(19) United States
(12) Patent Application Publication
(10) Pub. No.: US 2025/0249460 A1
(43) Pub. Date: Aug. 7, 2025

(54) SAMPLE MANAGEMENT CASSETTES, SYSTEMS, AND METHODS FOR CRYO-ELECTRON MICROSCOPY

(71) Applicant: MiTeGen, LLC, Ithaca, NY (US)

(72) Inventors: Alex Schreiber-Harris, Newfield, NY (US); Richard Jayne, Lansing, NY (US); David Closs, Freeville, NY (US); Robert E. Thorne, Ithaca, NY (US)

(73) Assignee: MiTeGen, LLC, Ithaca, NY (US)

(21) Appl. No.: 18/852,838

(22) PCT Filed: Mar. 31, 2023
(86) PCT No.: PCT/US2023/017096

§ 371 Date: Sep. 30, 2024

Related U.S. Application Data
(60) Provisional application No. 63/326,473, filed on Apr. 1, 2022.

(51) Int. Cl. B01L 9/00; G01N 1/42

(52) U.S. Cl. CPC B01L 9/52; G01N 1/42; B01L 2200/025; B01L 2300/0803; B01L 2300/0829; B01L 2300/12

(57) ABSTRACT

Presented are systems, methods, and devices for provisioning controlled sample support, precision sample immersion, and/or post-cooling sample storage of cryo-electron microscopy (cryo-EM) samples and grids. A puck is presented for manual or automated storage of cryo-EM sample grids after the grids and samples have been cryocooled. The puck carries one or more cryo-EM sample grids and includes a puck top portion and a puck bottom portion, each formed with a cryogenic-temperature compatible material. The bottom portion includes multiple receptacles that each accepts and holds a sample grid. The top portion includes an array of funnels. The puck top and bottom portions are assembled together by inserting the top portion into the bottom portion. When the puck may be immersed in a liquid cryogen, each funnel guides a sample grid released into an upper portion of the funnel downward and into a grid receptacle within a bottom portion of the funnel.

### CLAIM OF PRIORITY AND CROSS-REFERENCE TO RELATED APPLICATION

This application claims the benefit of and priority to U.S. Provisional Patent Application No. 63/326,473, which was filed on Apr. 1, 2022.

### TECHNICAL FIELD

This disclosure relates generally to the field of biotechnology. More particularly, aspects of this disclosure relate to the design of sample supports, sample cooling systems, and methods for handling samples for cryo-electron microscopy.

### BACKGROUND

Single-particle cryo-electron microscopy (cryo-EM) is a powerful approach to obtaining near-atomic-resolution structures of large biomolecular complexes, membrane proteins, and other targets of major scientific, pharmaceutical, and biotechnological interest. Development of high efficiency, high frame rate direct electron detectors, algorithms for correcting acquired “movies” for electron-beam-induced motion, and computational tools for classifying and averaging 105-106 molecular images have dramatically increased achievable resolution and throughput. Enormous investments in new cryo-EM facilities and the development of easy-to-use software have greatly expanded access, especially to non-experts. Unlike X-ray crystallography, cryo-EM necessitates only a small amount of biomolecular sample dispersed in solution. It allows structural study of systems that have been intractable to crystallization, and is becoming a go-to method for initial attempts at structure determination.

As in X-ray cryocrystallography, key challenges in single-particle cryo-EM are associated with sample preparation and handling. Many basic principles and methods in current use were developed in the 1980s, and recent sample preparation technology development is firmly rooted in ideas and methods developed at that time. Cryoprotectant-free buffers containing a biomolecule of interest (e.g., about 0.3 milligrams per milliliter (mg/mL)) may be dispensed onto glow-discharge cleaned and charged (e.g., 10-50 nanometer (nm)) thick carbon or metal (e.g., gold) “foil” that is supported, for example, by a 200-400 mesh, 10-25 micrometer (μm) thick, 3.05 millimeter (mm) diameter metal (e.g., copper or gold) grid. Excess sample may be removed by blotting and evaporation, with a target thickness of several times the biomolecular diameter (e.g., about 10-50 nm) to maximize image quality while limiting the fraction of biomolecules preferentially oriented by interaction with interfaces. To vitrify the buffer for the best imaging, the sample-containing foil+grid is plunged, e.g., at about 1-2 meters per second (m/s) into liquid ethane at a temperature (T) of about 90 Kelvin (K) (e.g., produced by cooling gas in a liquid-nitrogen-cooled cup). The sample is transferred from ethane to liquid nitrogen (LN₂), loaded into grid boxes, transferred to additional containers, and then into a storage Dewar. Samples are removed from the storage Dewar and grid boxes, and loaded into a cold microscope stage or else “clipped” and loaded into a cold sample cassette: the stage or cassette is then loaded in the microscope.

These complex procedures are fraught with difficulty. Grids and especially foils are routinely bent, torn, and otherwise damaged at each of the many manual handling steps. A new generation of sample preparation instruments integrates and automates sample deposition and blotting, sample plunging into liquid ethane, sample transfer into liquid nitrogen, and transfer into storage cassettes or containers. These instruments are complex and may be very expensive (e.g., costing in excess of $500,000 USD).

Systems and methods are currently available for cryocooling single-particle cryo-EM samples using only boiling liquid nitrogen as the coolant and obtaining high-quality images and molecular reconstructions. As a result, hazardous ethane, temperature-controlled stages to hold it, and robotics to transfer samples from ethane to liquid nitrogen for storage can be eliminated. This can substantially simplify designs for automated cryo-EM plunge coolers without compromises in performance.

### SUMMARY

The present disclosure relates to systems, methods, and devices using sample supports and sample cooling devices for cryo-electron microscopy.

Aspects of this disclosure include structures, apparatuses, and approaches to facilitate automated cryo-EM sample storage after cryocooling, particularly for systems that use only liquid nitrogen as the sample coolant, and to facilitate subsequent handling.

These structures and approaches are much simpler than robotics based approaches and can be implemented at much lower cost, without compromising performance.

Disclosed structures/apparatuses used for cryo-EM sample storage may be compatible with existing structures for both cryo-EM grid storage and for cryocrystallography sample storage. Since scientists generally use both cryo-EM and cryo-crystallography, structures that support sample handling in both approaches help to reduce complexity and cost for the end user.

Described herein are innovations for post-cooling sample storage of cryo-EM samples/grids in grid boxes.

According to aspects of this disclosure, the sample grid may be held using forceps that can be opened and closed robotically.

According to aspects of this disclosure, the forceps may be part of a sample wand that attaches to a vertical translation stage and that can be opened and closed via push-button actuation of the wand.

According to aspects of this disclosure, the sample grid may be translated vertically along a single axis from a start position in ambient or above-freezing temperature air or gas into liquid nitrogen for cooling, and then is translated along the same axis to a grid release point.

According to aspects of this disclosure, the grid may be released at the grid release point, by actuation of the forceps, into a funnel immersed in liquid nitrogen and positioned on the axis of vertical translation of the sample grid.

According to aspects of this disclosure, the funnel may have a tapering rectangular cross section ending in a narrow rectangular slot to precisely direct the grid.

According to aspects of this disclosure, the funnel opening at its top may have a width of about 2 mm to about 8 mm or, for at least some preferred configurations, about 4 mm, and a length of about 4 mm to about 10 mm or, for at least some preferred configurations, about 5 mm.

According to aspects of this disclosure, the funnel opening at its bottom may have a width of about 0.1 mm to about 1.5 mm or, for at least some preferred configurations, about 0.65 mm, and a length of about 3.2 mm to about 5 mm or, for at least some preferred configurations, about 3.5 mm.

According to aspects of this disclosure, a vertical distance between the top and bottom openings of the funnel may be about 5 mm to about 50 mm or, for at least some preferred configurations, about 16 mm.

According to aspects of this disclosure, one or more grid boxes may be held in a fixed position and orientation within a cryogenic-temperature-compatible grid box holder, that is in turn held on a stage. The grid box(es) and grid box holder may then be immersed in liquid nitrogen or other liquid cryogen. Each grid receptacle in each grid box can be positioned below the bottom opening of the funnel, allowing grids to be deposited in the grid box.

According to aspects of this disclosure, the grid box(es) and grid box holder may be replaced by a grid holder that directly has a pattern of receptacles for grids, as would be provided by an array of grid boxes.

According to aspects of this disclosure, the grid box holder may be attached to a stage that provides a single axis of rotation or a single axis of translation in a plane perpendicular to a plunge direction.

According to aspects of this disclosure, each grid box may have a grid holding receptacle layout that allows grid holding receptacles within each grid box to be positioned beneath the bottom outlet of the funnel. This may also allow grids to be deposited in the grid holding receptacles, one by one, via successive translations along a single axis or via successive rotations about a single axis of the stage and grid box holder.

According to aspects of this disclosure, the grid box holder may be attached to a stage that provides two axes of translational and/or rotational motion in a plane perpendicular to a plunge direction. This allows grid holding receptacles within grid boxes with arbitrary receptacle layouts to be positioned beneath the bottom outlet of the funnel, and may further allow grids to be deposited in the grid holding receptacles, one by one, via successive translations and/or rotations of the stage and grid box holder.

Also described herein are innovations for post-cooling sample handling to facilitate easy “clipping” of grids for loading into sample cassettes used in high-throughput cryo-TEMs.

According to aspects of this disclosure, a sample grid may be held using forceps that can be opened and closed robotically.

According to aspects of this disclosure, the sample grid may be translated vertically along a single axis from a start position in ambient or above-freezing temperature air or gas into liquid nitrogen or other liquid cryogen for cooling. Afterwards, the sample grid is then translated along the same single vertical axis to a grid release point.

According to aspects of this disclosure, the grid may be released by actuation of the forceps into a funnel immersed in the liquid nitrogen and whose top opening is positioned on the axis of vertical translation of the sample grid.

According to aspects of this disclosure, the funnel may have a tapering rectangular cross section.

According to aspects of this disclosure, the funnel may release grids into a grid clip ring holder, which has one or more receptacles for holding grid clip rings.

According to aspects of this disclosure, the grid clip ring may rest flat and not on edge on the bottom of the grid clip ring receptacle.

According to aspects of this disclosure, the bottom of the grid clip ring receptacle may be angled relative to the horizontal at an angle between 20 and 50 degrees.

According to aspects of this disclosure, the funnel's lower channel may curve so as to release the grid at an angle to the vertical, facilitating the grid drifting downward so that the grid lands with a specific side up within a grid clip ring.

According to aspects of this disclosure, the bottom end of the funnel may have features that facilitate release and subsequent motion of the grid at an angle to the vertical so that it lands with a preselected side up.

According to aspects of this disclosure, the bottom end of the funnel may have a cut-out on its lower side so that the grid is supported only on its edges via two ledges as it slides to the funnel's end. One ledge may end before the other so that the grid drifts sideways out of the funnel.

According to aspects of this disclosure, the ledges may end in a taper such that, when a portion of the grid edge closest to each sidewall of the funnel moves beyond and loses contact with the edge of the ledge, the trailing edge of the grid also moves beyond and loses contact with the edge of the ledge so that the grid experiences no net torque due to its interactions with gravity and the funnel.

According to aspects of this disclosure, a grid clip ring receptacle in the grid clip ring holder may be positioned so that its center is shifted relative to the center of the funnel outlet, in a plane perpendicular to the larger transverse dimension of the funnel, so as to facilitate transfer of grids through the funnel and into the grid clip ring with a desired orientation (foil or grid side up).

According to aspects of this disclosure, an upper portion of the grid clip ring receptacle may be configured to guide and correctly position a grid clipping tool so that grids within clip rings with the holder can easily be clipped by inserting a C-clip.

According to aspects of this disclosure, an array of funnels may be incorporated into a top portion of a holder of grid boxes, grids, or grid clip rings. These funnels may also removably attach to a bottom portion of the holder that has receptacles for grid boxes, grids, or grid clip rings, such that a grid released into each funnel in the top portion will be deposited into a unique grid box, grid receptacle, or grid clip ring receptacle in the bottom portion.

According to aspects of this disclosure, a series of grid clip rings may be held in a series of receptacles within a clip ring holder that is immersed in liquid nitrogen and that can be positioned just below the bottom outlet of the funnel. The clip ring holder has an array of receptacles that is sized and shaped to accept a clip ring and is compatible with grid clipping tools used to insert the C-clip spring and to clip grids. The walls of the receptacles may be angled outward or otherwise structured at the top to help guide the grid clipping tool to the bottom of each receptacle.

According to aspects of this disclosure, the grid clip ring holder may be attached to a stage that provides a single axis of rotation or a single axis of translation in a plane perpendicular to the grid plunge direction. This may allow grid holding receptacles containing grid clip rings within each grid clip ring holder to be positioned beneath the bottom outlet of the funnel, and may allow grids to be deposited in the grid clip rings within the clip ring receptacles, one by one, via successive translations or rotations of the stage and clip ring holder along a single translation or about a single rotation axis.

According to aspects of this disclosure, the grid clip ring holder may be attached to a stage that provides two axes of translational and/or rotational motion in a plane perpendicular to the plunge direction. This may allow grid clip rings within grid clip ring holding receptacles having arbitrary layouts within the grid clip ring holder to be positioned beneath the bottom outlet of the funnel. This may also allow grids to be deposited in the clip rings within the grid clip ring holding receptacles, one by one, via successive translations or rotations of the stage and clip ring holder.

Also described herein are innovations for post-cooling sample storage of cryo-EM samples/grids that are based on sample storage “pucks”-referred to as “UniPucks”-used in cryocrystallography.

According to aspects of this disclosure, a cryo-EM sample storage puck may consist essentially of a top portion and a bottom portion immersed in liquid nitrogen.

According to aspects of this disclosure, the cryo-EM sample storage puck may have a largely cylindrical shape that is sized and shaped to be compatible with hardware used for handling and storage of UniPucks.

According to aspects of this disclosure, the puck may have a diameter of about 62 mm to about 72 mm or, for at least some preferred configurations, about 67 mm. The puck may have a height of about 30 mm to about 35 mm or, for at least some preferred configurations, about 32.4 mm. The top portion of the puck may have a height of about 12 mm to about 24 mm or, for at least some preferred configurations, about 18 mm.

According to aspects of this disclosure, the puck may have a central hole with a semi-cylindrical notch in its outer periphery that cooperatively facilitate puck handling using “cryotongs” used with UniPucks.

According to aspects of this disclosure, the bottom portion of the puck may have multiple recesses each shaped to accept and fix the position and orientation of a grid box. It may be desirable that the top surface of the grid box be approximately flush with a top surface of the bottom of the puck.

According to aspects of this disclosure, the top portion of the puck may include an array of rectangular cross-section funnels. In this instance, a bottom portion of the puck may be loaded with grid boxes and the puck assembled by inserting the top portion in the bottom portion. When the puck is fully immersed in liquid nitrogen, the funnels guide grids are released into an upper portion of the funnel, then downward and into grid receptacles within the grid boxes held within the lower portion.

According to aspects of this disclosure, the funnels may be arranged in a circle, the grid boxes may be arranged in a circle, and the slots within the grid boxes may be arranged so that deposition of the grids into successive funnels and into the receptacles within the grid boxes within the holder may necessitate only rotation of the puck about its central axis.

According to aspects of this disclosure, the funnels may be arranged in concentric circles and provide curved paths for the grids so as to guide them into grid boxes having receptacles within them in the different configurations/layouts of the grid boxes. In so doing, grid deposition within the grid boxes may necessitate two axes of motion of the puck.

According to aspects of this disclosure, in place of recesses for grid boxes, a bottom portion of the puck may have an arrangement of receptacles each sized and shaped to accept a single grid with its plane in a vertical or near vertical orientation. In this instance, a top portion of the puck may include an array of rectangular cross-section funnels. After the puck is assembled by inserting the top portion into the bottom portion, and the puck is substantially or fully immersed in liquid nitrogen, the funnels guide the grids, which were released into an upper portion of the funnel, downward and into grid receptacles within the lower portion of the puck.

Also described herein are innovations for post-cooling loading of cryo-EM sample grids into clip rings using sample storage “pucks” used in cryocrystallography.

According to aspects of this disclosure, a cryo-EM sample storage puck may consist essentially of a top portion and a bottom portion, immersed in liquid nitrogen.

According to aspects of this disclosure, the cryo-EM sample storage puck may have a substantially cylindrical shape.

According to aspects of this disclosure, a bottom portion of the puck may have multiple cylindrical recesses that are shaped to accept clip rings used in “clipping” grids for automated handling (e.g., in some THERMOFISHER™ cryo-transmission electron microscopes), and to accept the grid clipping tool used to insert a C-springs into a clip that holds the grid in a clip ring.

According to aspects of this disclosure, a top portion of the puck may include an array of rectangular cross-section funnels. In this instance, a bottom portion of the puck may be loaded with clip rings, the puck may be assembled by inserting the top portion in the bottom portion, and then the puck may be substantially or fully immersed in liquid nitrogen. The funnels may guide grids, which were released into an upper portion of the funnel, downward and into clip rings held within the lower portion of the puck such that the same side of the grid reliably ends up facing down into the clip ring.

According to aspects of this disclosure, a grid path through the funnels may be curved and a bottom end of the funnel may be shaped so as to orient the grid to help ensure that it lands with the correct orientation within the clip ring after falling through the liquid nitrogen.

According to aspects of this disclosure, the funnels may be arranged in a circle and the cylindrical receptacles holding clip rings may be arranged in a circle to help ensure that deposition of the grids into successive funnels and into the clip rings necessitates only rotation of the puck about its central axis.

According to an aspect of this disclosure, a bottom of the funnel structure may be configured to inhibit release of a grid and grid clip ring from the grid clip ring receptacles if the puck is tilted, inverted, or subject to acceleration.

The above Summary does not represent every embodiment or every aspect of the present disclosure. Rather, the foregoing synopsis merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes any and all combinations and subcombinations of the elements and features presented above and below

### BRIEF DESCRIPTION OF THE DRAWINGS

FIGS. 1A-1C illustrate examples of cryo-EM grids, foils, clip rings and clips, and grid boxes.

FIGS. 2A-2C illustrate examples of pucks used to hold and store cryocrystallography samples.

FIGS. 3A-3C illustrate a representative wand-based system for holding and automated release of cryocrystallography samples and cryo-EM samples according to aspects of the present disclosure.

FIGS. 4A and 4B illustrate a representative funnel-based system for loading cryo-EM grids into grid boxes held within a grid box holder according to aspects of the present disclosure.

FIGS. 5A and 5B illustrate a representative funnel based system for loading cryo-EM grids into clip rings held within a clip ring holder according to aspects of the present disclosure.

FIGS. 6A and 6B illustrate a representative puck with an array of funnels and an array of receptacles for grid boxes, that can be used to load grids into grid boxes according to aspects of the present disclosure.

FIGS. 7A-7C illustrate another representative design for a puck with an array of funnels and an array of receptacles for grid boxes, that can be used to load grids into grid boxes according to aspects of the present disclosure.

FIGS. 8A-8C illustrate a representative puck with an array of funnels and an array of receptacles for grid clip rings that can be used to load grids into clip rings and to install C clips according to aspects of the present disclosure.

FIGS. 9A and 9B illustrate a representative two-rotation axis system for positioning pucks to place a given location (e.g., funnel) in the puck on the vertical axis of linear motion of the grid plunge stage according to aspects of the present disclosure.

FIGS. 10A-10C illustrate another representative design for a puck with an array of funnels and an array of receptacles for grid clip rings where the receptacles have inclined bottoms according to aspects of the present disclosure.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, subcombinations, permutations, groupings, and alternatives falling within the scope of this disclosure as encompassed, for example, by the appended claims

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Technical Filed, Background, Summary, and Detailed Description sections, but not explicitly set forth in the claims, should not be incorporated into the claims, singly or collectively, by implication, inference or otherwise.

The present disclosure describes devices and methods by which cryo-EM grids that are plunge cooled in a liquid cryogen may be automatically stored after cooling. In particular, described herein are devices and methods that allow grids that are translated along a single vertical axis during plunging to be translated and released on that same axis and then stored in grid boxes or loaded into clip rings for subsequent handling. The disclosure provides a dramatically simplified and highly convenient approach to automated post-cooling grid handling and storage.

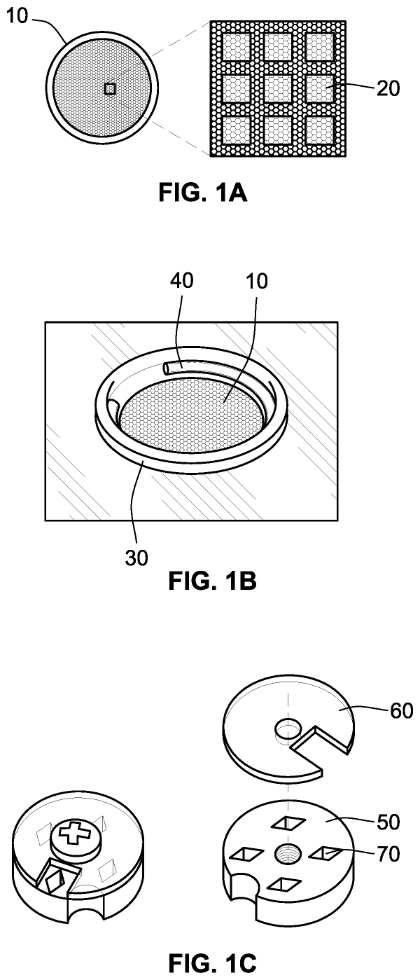

FIG. 1A shows an example of cryo-EM grid 10 covered with a thin holey foil 20. Grids may have a diameter of about 3.05 mm and a thickness of about 10-25 micrometers, whereas foils may have a thickness of about 10-50 nanometers. Cryo-EM samples may include biomolecules in solution and may be deposited onto the foil. The grid, foil, and sample solution are then plunge cooled in liquid nitrogen or liquid ethane.

FIG. 1B shows an example of a grid clipping system, e.g., used in THERMOFISHER™ cryo-TEMs, to facilitate automated grid handling. The grid 10 is placed with foil side down into a clip ring 30. A C-clip 40 is then inserted into the clip ring using a special tool, so that the clip rigidly holds the grid within the clip ring. The clip ring may have an outside diameter of about 3.5 mm, and inner diameter of about 2.5 mm, and a height of about 0.4 mm.

FIG. 1C shows an example of a grid storage box 50 and storage box cover 60 used to store grids after cooling. The boxes may have a diameter of about 13.8 mm, a height of about 4 mm, and a semicircular notch on one side with a radius of about 1.7 mm. The receptacles 70 within the boxes may be rhombohedral or diamond-shaped and may each accept one grid at a time, oriented so that the plane of the grid is approximately parallel to the central axis of the grid box. The dimensions of these grid-receiving receptacles may be about 2-2.5 mm from corner to corner along the short diagonal, and about 3.5-4.5 mm along the long diagonal. The arrangement of the receptacles is not standardized and varies between manufacturers. In current practice, grids held in forceps are manually transferred from a plunge cooler stage and released into the grid boxes, or else are transferred using a robotic mechanism, where the grid boxes are held in a stationary array and the robot arm moves between grid box receptacles.

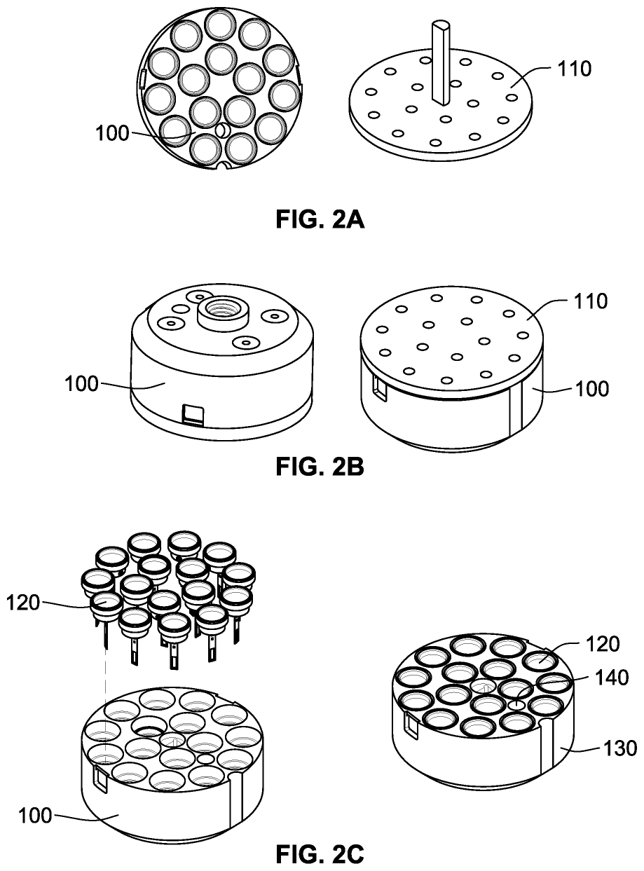

FIGS. 2A, 2B and 2C show examples of pucks-referred to colloquially as “UniPucks”—that are used to hold and store cryocrystallography samples. The pucks (FIGS. 2A and 2B) have a top portion 100 and a bottom portion 110. The pucks may have a diameter of about 67 mm and an overall height of about 32.4 mm. Samples for cryocrystallography 120 are loaded in the top portion as shown, and then the bottom portion is attached for storage and shipping. At an X-ray beamline equipped with automated sample handling equipment, the pucks are placed bottom side down, the top 100 is removed, exposing cryocrystallography samples 120 that can be picked up and replaced one by one using a robotic arm. The puck has a semicylindrical notch 130 in one side and a second hole 140 that allow it to be gripped with a suitable gripping device (e.g., “cryotongs”), and that can also be used to orient and hold pucks in storage canes.

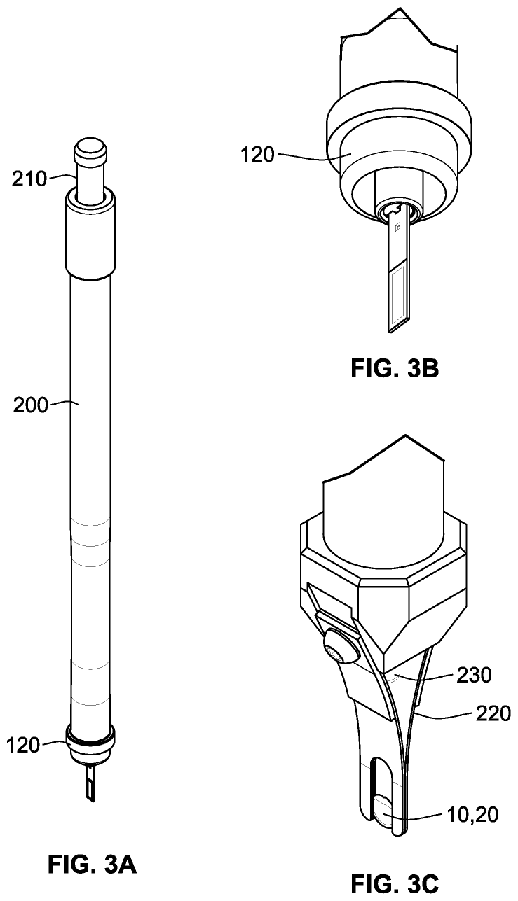

FIGS. 3A, 3B and 3C show an example of a wand-based system for holding and automated release of cryocrystallography samples and cryo-EM samples according to our previously disclosed art. For crystallography samples (FIGS. 3A and 3B), a sample 120 is held at one end of the wand 200 by a magnet, and can be released from the wand by pushing on the spring loaded button 210, connected to a rod ending in a flat head that pushes the sample off the end of the wand. For cryo-EM grids 10 covered with foil 20, the end of the wand has a pair of spring-loaded forceps 220 that grip the grid. The grid can be released by pushing the spring loaded button at the other end of the wand, which drives a rod 230 between the forceps to separate them.

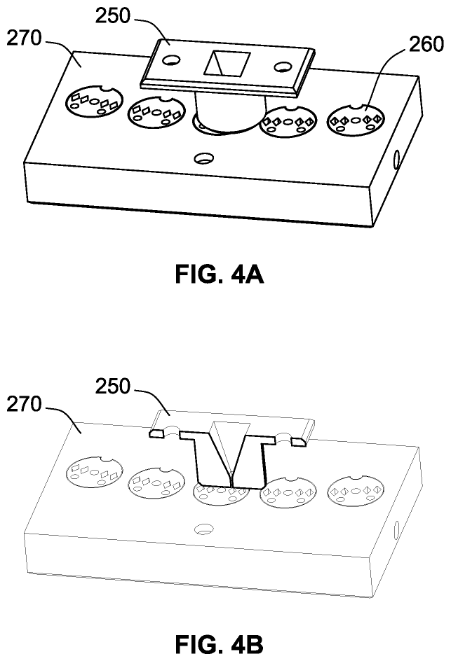

FIGS. 4A and 4B show an example of a funnel-based system for loading cryo-EM grids into grid boxes held within a grid box holder according to the present disclosure. In FIG. 4A, the funnel 250 is within a component that is attached at a fixed position within a plunge cooling device, centered along the grid plunge path, entirely within the liquid cryogen. The funnel may have a distance between its top and bottom of between about 5 mm and about 50 mm or, for at least some desired configurations, about 16 mm. The funnel opening at its top may have a width of between about 2 mm and about 8 mm or, for at least some desired configurations, about 4 mm, and length between about 4 mm and about 10 mm or, for at least some desired configurations, about 5 mm. The funnel opening at its bottom may have a width between about 0.1 mm and about 1.5 mm or, for at least some desired configurations, about 0.65 mm, and a length between about 3.2 mm and about 5 mm or, for at least some desired configurations, about 3.5 mm. A grid box holder 270 holds grid boxes 260 in a fixed orientation. The grid box holder is on a stage that allows positioning of receptacles within each grid box directly beneath the lower outlet of the funnel. For grid boxes 260 with a linear arrangement of receptacles, the grid boxes can be arranged in an arc as in FIG. 4A so that all receptacles in all grid boxes can, one by one, be positioned directly beneath the funnel outlet using a stage with a single axis of rotational motion. For more general grid box receptacle layouts (e.g., as in FIG. 1C), the stage may have two axes of motion. The grid boxes could also be eliminated and an array of grid receptacles fabricated directly within the “grid box holder” 270. The diamond-shaped grid receptacles may have dimensions 2.0 to 2.5 mm from corner to corner along the short axis and 3.5 to 4.5 mm from corner to corner along the long axis. FIG. 4B shows the cross-section of the funnel 250, showing that grids exit traveling with their plane parallel to the plunge axis, so that they drop edge-on into the grid box receptacles 270.

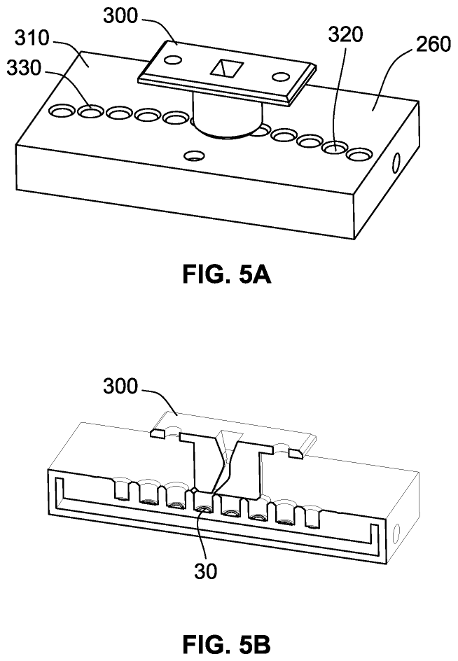

FIGS. 5A and 5B show an example of a funnel based system for loading cryo-EM grids into clip rings held within a clip ring holder according to the present disclosure. Clip rings may have an outer diameter of about 3.5 mm, an inner diameter of about 2.5 mm, and a height of about 0.4 mm. In FIG. 5A, the funnel 300 is within a component that is attached at a fixed position, centered along the grid plunge path, entirely within the liquid cryogen. A clip ring holder 310 has a series of flat bottom cylindrical receptacles 320 that accept clip rings 30. e.g., used in THERMOFISHER™ cryo-TEMs, to hold grids for automated handling within the microscope. The diameter of the clip ring receptacles 320 is matched to the diameter of the clip rings 30 and to the diameter of a tool used to insert C-clips 40 into the rings, used to hold grids within them. The diameter may be between about 3.6 mm and about 3.8 mm: a minimum depth of the receptacles may be set by a thickness of the clip rings, and nay be at least about 0.4 mm. The clip ring receptacles have an angled top edge to facilitate centering of the clipping tool. The depth of the clip ring receptacles 320 is determined by the length of the relevant portion of the tool used to insert the clip rings. In a prototype, the diameter at the top of the receptacles is 5 mm and the depth is 5.3 mm, but the depth and width can be adjusted based on the diameter of the clip ring and length of the clipping tool used. The clip ring holder 310 is on a stage (not shown) that allows positioning of each clip ring receptacle 320 directly beneath the lower outlet of the funnel 300.

With the arrangement of clip ring receptacles along an arc as in FIG. 5A, all clip ring receptacles within the clip ring holder can, one by one, be positioned directly beneath the funnel outlet using a stage with a single axis of rotational motion. For more general clip ring receptacle layouts the stage may have two only axes of motion. FIG. 5B shows the cross-section of the funnel 300, whose lower end is at a substantial angle to the vertical so that grids are projected from the funnel with a well-defined lower and upper side and so that they land in the clip rings with a well-defined side (e.g., the foil side) down.

Extensive experimentation with prototypes of the grid box system in FIG. 4, immersed in liquid nitrogen and acetone (which has similar viscosity and density to liquid nitrogen) shows that the funnels reliably deliver grids into grid boxes, with essentially 100% success. Success is maximized by releasing the grids when they are within the upper portion of the funnel, rather than above the funnel. Experimentation with the curved funnel of FIG. 5 shows that the curved funnel reliably projects grids with a given side up, so that they land with that side up essentially 100% of the time on the bottom of a container of the same depth as the clip ring receptacles in FIGS. 5A and 5B. When used with the clip ring receptacles, sometimes a grid hits the receptacle wall and flips, landing with the other side down in the clip ring. Experiments are in progress to identify the most reliable way to eliminate this, including constricting the funnel at its lower end to reduce the grid's exit speed, reducing the height of the funnel through which the grid falls, and adding a second, oppositely tilted shelf at the bottom end of the funnel that stops the grid, dissipating some of its kinetic energy, and allows it to flop over and slide down in the opposite direction, to give more reproducible orientation on landing in the clip ring.

Nearly all researchers who use single-particle cryo-electron microscopy to determine the structures of biomolecules also use X-ray cryocrystallography. As a result, common methods and hardware used to store and transport cryo-EM samples are based on existing “standardized” hardware for cryocrystallography, including sample pucks as in FIG. 2, puck storage “canes” (which consist of a stacked series of shelves into which pucks can be inserted), and cryogenic storage Dewars. As a result, a method and hardware for automated storage of cryo-EM samples after plunge cooling that is compatible with cryocrystallography tools and hardware is desirable.

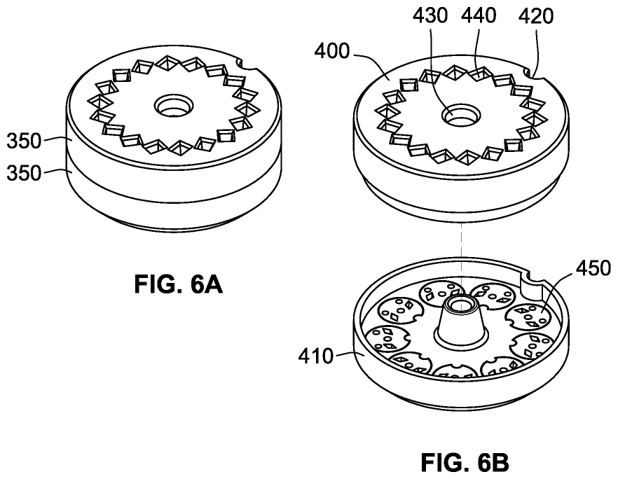

FIGS. 6A and 6B show another example of a puck format that may be used in cryocrystallography shown in FIG. 2. The cryo-EM “puck” 350 in FIG. 6A has a diameter of between 62 mm and 72 mm or, for at least some desired configurations, about 67 mm (e.g., for UniPucks), and a height between 30 mm and 35 mm or, for at least some desired configurations, about 32.4 mm (e.g., for UniPucks). The puck consists of an upper part 400 and a lower part 410. The upper part has a height between 12 mm and 24 mm or, for at least some desired configurations, about 18 mm. Both upper and lower parts have a semi-cylindrical notch 420 in their outer periphery (as in the UniPucks of FIGS. 2A-2C, 130) that facilitate puck handling using cryotongs and subsequent storage. The puck may have central hole 430 for precise positioning and alignment on a rotation/translation stage. This hole and/or another hole (not shown, but as in the UniPuck of FIGS. 2A-2C, 140) can provide a second gripping point for cryotongs.

The top portion of the puck includes a series of funnels 440 with rectangular cross-sections that have a wide end on the top surface of the top portion and a narrow tapered end at the bottom surface of the top portion. The bottom portion of the puck 410 has multiple receptacles each shaped and sized to accept and fix the position and orientation of a “standard-format” grid box 450. When the top and bottom portions are assembled together, each funnel in the top portion has its bottom end aligned and in near contact with a grid receptacle in a grid box held in the bottom portion, so that when grids are released into each of the funnels, they fall and are guided into each of the grid receptacles in each of the grid boxes. In the example shown, the grid boxes are arranged in a circle, each has grid receptacles that lie on a circle, and the funnels are arranged in a circle and guide the grids straight down into each receptacle. This design allows all grid box receptacles to be loaded using a single axis of puck rotation.

To prevent grids from falling out if the puck is inverted, the top portion can be covered with a cap: the cap could be of magnetic steel and the top portion may include one or more magnets: the cap may insert and be captured by (e.g., using twist and lock) the central hole of the top portion: or the bottom portion may rotate slightly after grid loading so that the funnels no longer align with the grid box receptacles and so that the each grid box receptacle is covered by a solid region of the top portion.

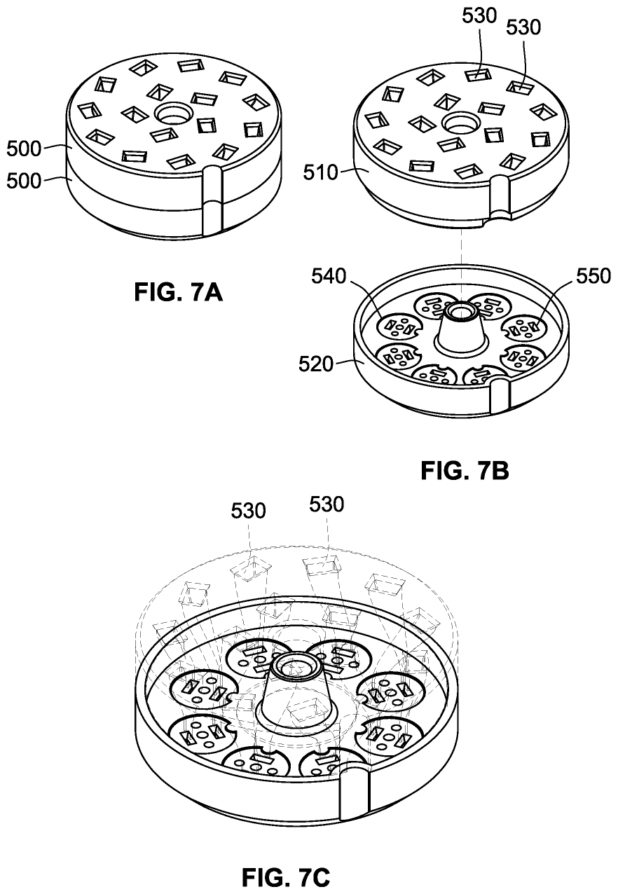

FIGS. 7A-7C show another example of a puck 500 in which the grid boxes 540, the grid receptacles 550, and the grid box receptacles in the bottom portion 520 of the puck may have a more complicated arrangement, such that the grid receptacles cannot be arranged in a circle as in FIGS. 6A and 6B. In this case, the funnels 530 in the top portion 510 can be curved as shown in FIG. 7C to deliver grids to each grid receptacle. The top openings of the funnels can be arranged in concentric circles so that they can be accessed by placing the puck on a stage with one rotational and one translational degree of freedom, but no particular symmetry of the funnel arrangement is in general needed. The top portion can be easily customized for different layout grid boxes.

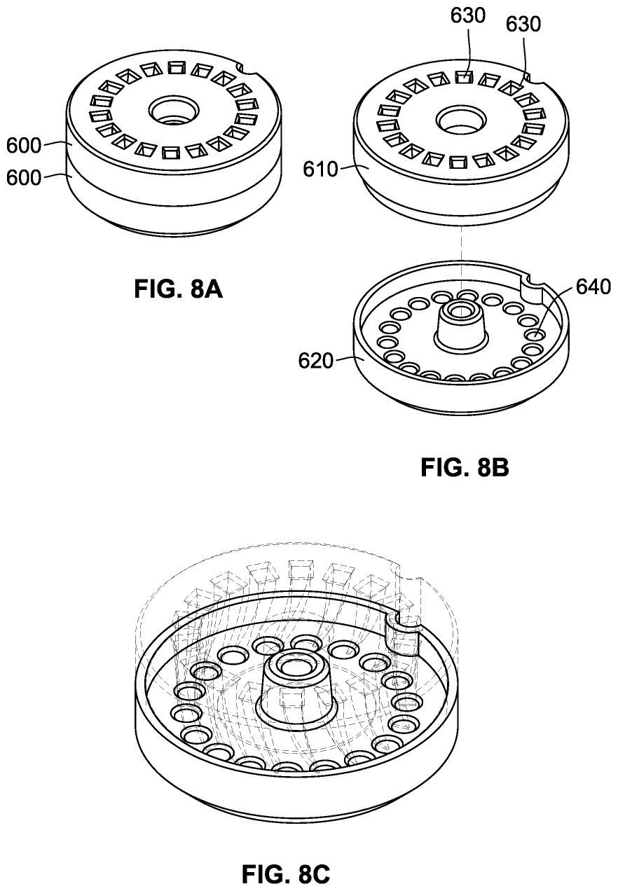

FIGS. 8A-8C show another example of a puck 600 with a top portion 610 and a bottom portion 620. The top portion has an array of funnels 630, and the bottom portion has an array of receptacles 640 for grid clip rings. Grids can be loaded into the clip rings by releasing them into the funnels. Prior to loading into a cryo-TEM sample cassette, the top portion can be removed and the C clips inserted into the rings using a commercially available clipping tool. The clipped grids can then be removed and transferred to the cassette.

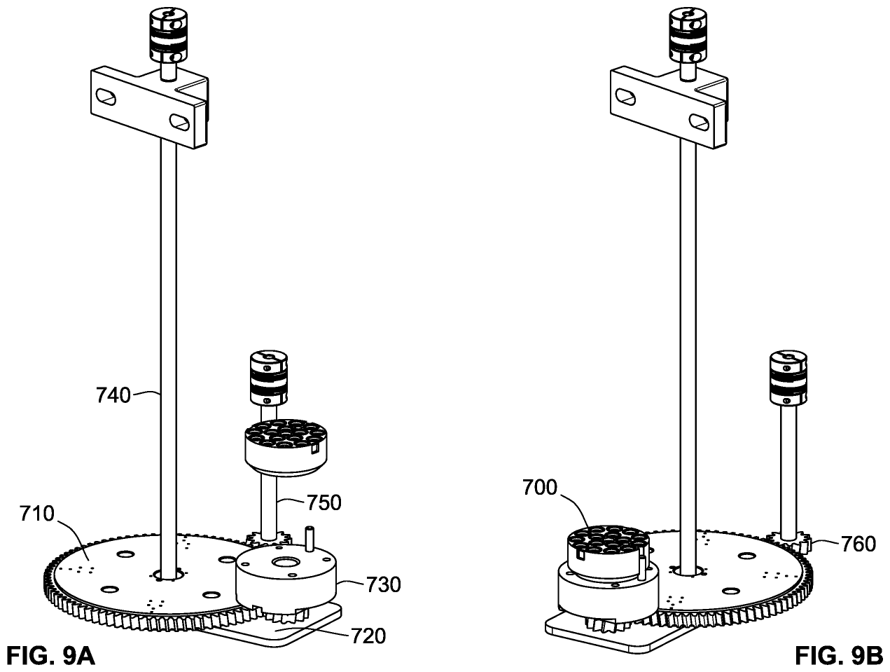

FIGS. 9A and 9B show an example of a mechanism combining two axes of rotation that can be used to position a puck, as in FIGS. 6-8 or a UniPuck 700, so that any position on the puck's surface and thus any of the funnels can be placed along a vertical plunge axis (not shown) that lies on a circle concentric with the large gear 710 that passes through the puck center. The gears and platforms all are immersed in liquid nitrogen during operation. The plate 720 that holds the platform 730 onto which the puck 700 is placed is rotated by the main drive shaft 740, passing through the large gear 710. The puck platform and puck are rotated about their axis by the second drive shaft 750 and attached gear 760, which rotates the large gear 710.

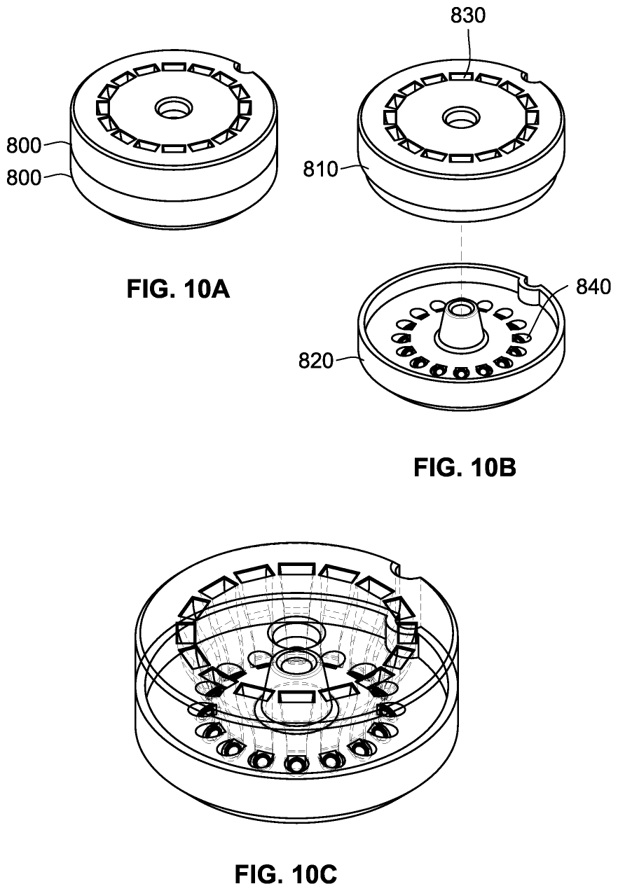

FIGS. 10A-10C show an example of a puck 800 with a top portion 810 and a bottom portion 820. The top portion has an array of funnels 830, and the bottom portion has an array of receptacles 840 for grid clip rings. The bottom of each grid clip ring receptacle is angled relative to the horizontal. e.g., between about 15 and 50 degrees. Grids can be loaded into the clip rings by releasing them into the funnels. Angling of the clip rings relative to the horizontal produced by the angled bottoms of the clip ring receptacles facilitates grid motion into the clip ring with a defined side-foil side or grid side-up. The side that lands up in the clip ring is determined by which side of the grid faces toward (or away) from the central axis of the puck when it is loaded into the funnel 830. The outlet of the funnel can be offset inward along a radius of the puck relative to the grid clip ring receptacle so as facilitate grid motion into the clip, and also to inhibit motion of the clip ring and grid if the puck is tilted, inverted, or subject to acceleration. Prior to loading into a cryo-TEM sample cassette, the top portion can be removed and the C-clips inserted into the rings using a commercially available clipping tool. The upper portion of each grid receptacle can be angled as in FIGS. 8A-8C or otherwise configured to securely mate with the clipping tool during clipping. The clipped grids can then be removed and transferred to the cassette.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein: any and all modifications, changes, and variations apparent from the foregoing descriptions are within the scope of the disclosure as defined, for example, by the appended claims. Moreover, the present concepts expressly include any and all combinations and subcombinations of the preceding elements and features. Additional features may be reflected in the following clauses:

Clause 1: a puck for manual or automated storage of cryo-electron microscopy (cryo-EM) sample grids after the grids and the samples they hold have been cryocooled, the puck comprising a 3.05 millimeter diameter cryo-EM sample grid: a puck top portion and a puck bottom portion, each comprised of cryogenic temperature compatible materials; a bottom portion comprising multiple receptacles that each accept and hold one cryoEM sample grid in a largely vertical orientation; and a top portion comprising an array of funnels; such that when the puck top and bottom are assembled together by inserting the top portion into the bottom portion, and the puck is fully immersed in a liquid cryogen, the funnels guide a cryo-EM sample grid released into an upper portion of each funnel downward and into a grid receptacle within the bottom portion.

Clause 2: the puck of clause 1, where the puck is sized and shaped to be compatible with hardware used for manual and handling and storage of pucks in cryocrystallography.

Clause 3: the puck of clause 1 or clause 2, where the puck has a diameter of 67 mm.

Clause 4: the puck of any one of clauses 1 to 3, where the puck has a height between 12 and 24 mm, and preferably 18 mm.

Clause 5: the puck of any one of clauses 1 to 4, where the puck has a central hole and semi-cylindrical notch in its outer periphery that facilitate its handling using “cryotongs” used with cryocrystallography pucks.

Clause 6: the puck of any one of clauses 1 to 5, where there is one funnel for each grid receptacle, such that each funnel guides a grid into one and only one grid receptacle.

Clause 7: the puck of any one of clauses 1 to 6, where the funnels of the top portion have a largely rectangular cross-section.

Clause 8: the puck of clause 7, where the funnel has a tapering cross-section ending in a narrow rectangular slot to precisely direct a grid into a grid receptacle.

Clause 9: the puck of clause 8, where the funnel opening at its top has a width between 2 and 8 mm and preferably 4 mm, and a length between 4 and 10 mm and preferably 5 mm.

Clause 10: the puck of clause 9, where the funnel opening at its bottom has a width between 0.5 mm and 1.5 mm and preferably 0.65 mm, and a length between 3.2 and 5 mm and preferably 3.5 mm.

Clause 11: the puck of clause 9, where the vertical distance between the top and bottom of the funnel is between 5 and 50 mm and preferably 16 mm.

Clause 12: the puck of any one of clauses 1 to 11, where the grid receptacles are formed in separate grid boxes, where the bottom portion of the puck contains receptacles that hold and fix the position and orientation of each grid box within the bottom portion.

Clause 13: the puck of any one of clauses 1 to 12, where the grid receptacles are arranged in concentric circles coaxial with the central axis of the puck.

Clause 14: the puck of any one of clauses 1 to 13, where the funnels are curved so as to direct grids from a release position within a horizontal plane near the top of the funnels to different position within a parallel horizontal plane that includes the grid receptacle openings where a grid receptacle is located.

Clause 15: the puck of any one of clauses 1 to 14, further comprising a stage beneath the puck that allows the puck to be positioned so that any of the funnels in the top portion can be positioned along a single vertical axis, from which grids are released after cryocooling.

Clause 16: a puck for storage of a cryo-electron microscopy (cryo-EM) sample, the puck comprising: a puck body formed with a cryogenic-temperature compatible material and including multiple sample grids each configured to receive thereon a sample, the puck body having a puck top portion and a puck bottom portion, the puck bottom portion including multiple grid receptacles each configured to receive at least one of the sample grids, and the puck top portion including an array of funnels, wherein the puck top portion and the puck bottom portion are configured to assemble together by fixing the puck top portion to the puck bottom portion, and wherein each of the funnels, when the puck is immersed in a liquid cryogen, is configured to guide one of the sample grids, released into an upper portion of each of the funnels, downward and into one of the grid receptacles within the puck bottom portion.

Clause 17: the puck of clause 16, wherein the puck body is a bipartite construction consisting essentially of the puck top portion and the puck bottom portion.

Clause 18: the puck of clause 16 or clause 17, wherein the puck bottom portion and the grid receptacles are formed as a first single-piece construction, and wherein the puck top portion and the funnels are formed as a second single-piece construction.

Clause 19: the puck of any one of clauses 16 to 18, wherein the puck body has an outer diameter of about 62 mm to about 72 mm.

Clause 20: the puck of any one of clauses 16 to 19, wherein the puck body has a height of about 30 mm to about 35 mm.

Clause 21: the puck of clause 20, wherein the puck top portion has a height of about 12 mm to about 24 mm.

Clause 22: the puck of any one of clauses 16 to 21, wherein the puck body defines a central hole and a semi-cylindrical notch cooperatively configured to mate with handling tongs, the central hole extending axially through a center of the puck body, and the semi-cylindrical notch extending axially through an outer periphery of the puck body.

Clause 23: the puck of any one of clauses 16 to 22, wherein each of the funnels is aligned with a respective one of the grid receptacles and configured to guide thereto a respective one of the sample grids.

Clause 24: the puck of any one of clauses 16 to 23, wherein each of the funnels of the puck top portion has a substantially rectangular or square cross-section.

Clause 25: the puck of any one of clauses 16 to 24, wherein each of the funnels has a tapering cross-section with opposing top and bottom ends, the top end having a square or rectangular top slot with a first size, and the bottom end having a square or rectangular bottom slot with a second size less than the first size.

Clause 26: the puck of clause 25, wherein the top slot at the top end of each of the funnels has a width of about 2 mm to about 8 mm and a length of about 4 mm to about 10 mm.

Clause 27: the puck of clause 26, wherein the bottom slot at the bottom end of each of the funnels has a width of about 0.5 mm to about 1.5 mm and a length of about 3.2 mm to about 5 mm.

Clause 28: the puck of any one of clauses 16 to 27, wherein the grid receptacles are formed in separate grid boxes, and wherein the puck bottom portion of the puck body contains multiple box holders each configured to hold and fix the position and orientation of a respective one of the grid boxes within the puck bottom portion.

Clause 29: the puck of any one of clauses 16 to 28, wherein the grid receptacles are arranged in concentric circles coaxial with a central axis of the puck body.

Clause 30: the puck of any one of clauses 16 to 29, wherein each of the funnels is curved so as to direct a respective one of the grids from a first position at a top of the funnel and within a first vertical plane to a second position at a bottom of the funnel and within a second vertical plane laterally spaced from the first vertical plane.

Clause 31: the puck of any one of clauses 16 to 30, further comprising a stage beneath the puck body that allows the puck body to be positioned so that the funnels in the puck top portion are positionable along a single vertical axis along which the sample grids release after cryocooling.

Clause 32: the puck of any one of clauses 16 to 31, wherein each of the sample grids is circular and has a diameter of about 3 mm.

Clause 33: the puck of any one of clauses 16 to 32, wherein the grid receptacles are sized and shaped to hold the sample grid with faces thereof in a substantially vertical orientation.

Clause 34: the puck of clause 33, wherein each of the grid receptacles has a diamond-shaped cross-section and a height of about 3.5 mm to about 9 mm.

Clause 35: the puck of any one of clauses 16 to 34, wherein each of the grid receptacles is cylindrical and has a flat bottom inclined at an angle of about 15 to about 50 degrees from a horizontal plane

Clause 36: the puck of clause 35, wherein each of the grid receptacles holds a grid clip ring into which one of the funnels directs one of the sample grids such that the sample grid lands within the grid clip ring with a predetermined side of the sample grid facing upward.

Clause 37: the puck of clause 36, wherein each of the grid receptacles has a diameter of about 3.6 mm to about 3.8 mm, each of the grid clip rings has a diameter less than about 3.6 mm, and each of the grid clip rings seats against a bottom of a respective one of the grid receptacles.

Clause 38: the puck of clause 36 or clause 37, wherein each of the grid receptacles includes a grid top portion configured to securely mate with a grid clipping tool to thereby enable insertion of a clip into the sample grid while the sample grid and the clip ring are resting within the grid receptacle within the puck bottom portion of the puck body.

1. A puck for a cryo-electron microscopy (cryo-EM) system with multiple sample grids each configured to receive a sample, the puck comprising:
a puck body formed with a cryogenic-temperature compatible material, the puck body having a puck top portion and a puck bottom portion, the puck bottom portion including multiple grid receptacles each configured to receive at least one of the sample grids, and the puck top portion including an array of funnels,
wherein the puck top portion and the puck bottom portion releasably assemble together by fixing the puck top portion to the puck bottom portion, and
wherein each of the funnels, when the puck is immersed in a liquid cryogen, is configured to guide one of the sample grids, released into an upper portion of each of the funnels, downward and into one of the grid receptacles within the puck bottom portion.

2. The puck of claim 1, wherein the puck body is a bipartite construction consisting essentially of the puck top portion and the puck bottom portion.

3. The puck of claim 1, wherein the puck bottom portion and the grid receptacles are formed as a first single-piece construction, and wherein the puck top portion and the funnels are formed as a second single-piece construction.

4. The puck of claim 1, wherein the puck body has an outer diameter of about 62 (millimeters) mm to about 72 mm and a height of about 30 mm to about 35 mm, and wherein the puck top portion has a puck top height of about 12 mm to about 24 mm.

5. (canceled)

6. (canceled)

7. The puck of claim 1, wherein the puck body defines a central hole and a semi-cylindrical notch cooperatively configured to mate with handling tongs, the central hole extending axially through a center of the puck body, and the semi-cylindrical notch extending axially through an outer periphery of the puck body.

8. The puck of claim 1, wherein each of the funnels is aligned with a respective one of the grid receptacles and configured to guide thereto a respective one of the sample grids.

9. The puck of claim 1, wherein each of the funnels of the puck top portion has a substantially rectangular or square cross-section.

10. The puck of claim 1, wherein each of the funnels has a tapering cross-section and opposing top and bottom ends, the top end of the funnel having a square or rectangular top slot with a first size, and the bottom end of the funnel having a square or rectangular bottom slot with a second size less than the first size.

11. The puck of claim 10, wherein the top slot at the top end of each of the funnels has a width of about 2 mm to about 8 mm and a length of about 4 mm to about 10 mm, and wherein the bottom slot at the bottom end of each of the funnels has a width of about 0.5 mm to about 1.5 mm and a length of about 3.2 mm to about 5 mm.

12. (canceled)

13. The puck of claim 1, wherein the grid receptacles are formed in separate grid boxes, and wherein the puck bottom portion of the puck body contains multiple box holders each configured to hold and fix the position and orientation of a respective one of the grid boxes within the puck bottom portion.

14. The puck of claim 1, wherein the grid receptacles are arranged in concentric circles coaxial with a central axis of the puck body.

15. The puck of claim 1, wherein each of the funnels is curved so as to direct a respective one of the sample grids from a first position at a top end of the funnel and within a first vertical plane to a second position at a bottom end of the funnel and within a second vertical plane laterally spaced from the first vertical plane.

16. The puck of claim 1, further comprising a stage beneath the puck body that allows the puck body to be positioned so that the funnels in the puck top portion are positionable along a single vertical axis along which the sample grids release after cryocooling.

17. (canceled)

18. The puck of claim 1, wherein the grid receptacles are sized and shaped to hold the sample grids with faces thereof in a substantially vertical orientation.

19. The puck of claim 18, wherein each of the grid receptacles has a diamond-shaped cross-section and a height of about 3.5 mm to about 9 mm.

20. The puck of claim 1, wherein each of the grid receptacles is cylindrical and has a flat bottom inclined at an angle of about 15 degrees to about 50 degrees from a horizontal plane.

21. The puck of claim 20, wherein each of the grid receptacles holds a grid clip ring into which one of the funnels directs one of the sample grids such that the sample grid lands within the grid clip ring with a predetermined side of the sample grid facing upward.

22. The puck of claim 21, wherein each of the grid receptacles has a diameter of about 3.6 mm to about 3.8 mm, each of the grid clip rings has a diameter less than about 3.6 mm, and each of the grid clip rings seats against a bottom of a respective one of the grid receptacles.

23. The puck of claim 21, wherein each of the grid receptacles includes a grid top portion configured to securely mate with a grid clipping tool to thereby enable insertion of a clip into the sample grid while the sample grid and the clip ring are resting within the grid receptacle within the puck bottom portion of the puck body.

24. A method of using a sample puck for a cryo-electron microscopy (cryo-EM) system, the method comprising:
receiving multiple sample grids each receiving thereon a sample;
receiving the sample puck having a puck body formed with a cryogenic-temperature compatible material, the puck body including a puck top portion opposite a puck bottom portion, the puck bottom portion including multiple grid receptacles, and the puck top portion including an array of funnels;
fixing the puck top portion onto the puck bottom portion such that the funnels align with the grid receptacles; and
positioning the sample grids into the grid receptacles by immersing the sample puck in a liquid cryogen such that each of the funnels guides one of the sample grids, released into an upper portion of each of the funnels, downward and into one of the grid receptacles within the puck bottom portion.
